(19) United States
(12) Patent Application Publication
(10) Pub. No.: US 2012/0020859 A1
(43) Pub. Date: Jan. 26, 2012

(54) Method for Capturing Carbon Oxides with a View to Subsequently Storing Same

(75) Inventors: Georges Fremy, Sauveterre de Bearn (FR); Dominique Plee, Lons (FR)

(73) Assignee: Arkema France

(21) Appl. No.: 13/144,875

(22) PCT Filed: Feb. 16, 2010
(86) PCT No.: PCT/FR2010/050261

§ 371 Date: Oct. 3, 2011

(30) Foreign Application Priority Data
Feb. 18, 2009 (FR) 0951049

(51) Int. Cl. B01D 53/62; C01B 31/18; C01B 31/20; C01B 31/00

(52) U.S. Cl. 423/223; 423/210; 423/246; 423/226; 423/415.1; 423/418.2; 423/437.1

(57) ABSTRACT

The present invention relates to a method for capturing carbon oxides, in particular for recovering carbon oxides from an industrial facility, and specifically to a method for capturing CO₂ contained in a gas flow with a view to storing said CO₂, said method including placing said gas flow in contact with a solvent including an organometallic compound, such that said solvent captures said carbon oxides to form an enriched solvent. The present invention relates in particular to the use of said capture method in post-combustion or pre-combustion processes.

One subject of the present invention is a process for capturing carbon oxides (carbon monoxide and dioxide), and in particular for recovering carbon oxides from an industrial plant and more particularly a process for capturing CO₂ contained in a gas stream with a view to storing this CO₂.

The process according to the invention is particularly suitable for the recovery of carbon oxides, preferably carbon dioxide, when they are recovered from a gas at a pressure above atmospheric pressure, with a view to storage. Such as gas is typically a syngas produced by gasification of coal or by reforming of natural gas, which may or may not be followed by a reaction known as the water-gas shift reaction.

Carbon oxides, and in particular carbon dioxide, are removed from the gas in question with a view either to using the hydrogen as fuel or with a view to using a mixture of carbon monoxide and hydrogen, or for synthesizing methanol, or manufacturing fuels, or for any other usage when syngas is used.

Carbon dioxide (CO₂) makes up the composition of greenhouse gases (GHGs) which are known for being involved in global warming. The Kyoto protocol commits signatory developed countries to reduce their GHG emissions by 5.2% on average over the period 2008-2012. According to the Intergovernmental Panel on Climate Change (IPCC), global emissions should be reduced by more than half by 2050 and, for certain countries such as France, this translates into a factor of four reduction in emissions.

The content of CO₂ in the atmosphere was 280 ppm at the beginning of the XIXth century and it is 370 ppm today with an increase of 60 ppm in the last 50 years. Today, the atmosphere contains around 700 Gt of CO₂.

CO₂ remains in the atmosphere over a long period of time. It slowly dissolves in the oceans and contributes to their acidification. It is estimated that between 30% and 50% of all the CO₂ emitted by anthropogenic emissions have been trapped by the oceans.

The combustion of fossil energy (coal, oil and gas) in transportation, the production of electricity and industry and also housing, are the main sources of releases of CO₂ into the atmosphere with 25 billion tonnes per year on a global scale.

Capturing CO₂ at the source of large electricity production and heavy industry sites in order to store it constitutes, on a global scale, one of the most promising research pathways for meeting the Kyoto criteria.

For many experts, the capture and storage of CO₂ even appears to be the only solution for limiting these emissions on a large scale. An IPCC report acknowledges that these technologies are a means of partly solving the problem of climate change.

This is even truer since coal reserves are estimated at several hundreds of years, whereas oil reserves are numbered rather in tens of years. Coal, used for example in thermal power plants, nevertheless has the drawback of releasing more CO₂ per kWh than methane, mainly around 750 g of CO₂ per kWh.

Regarding the existing technologies for capturing CO₂, three technological routes are in competition:

The first route is post-combustion which consists in removing the CO₂ from the combustion gases released in the stack. The gases that escape from a thermal power plant consist of nitrogen, CO₂ and impurities of NOx or SO₂ type. The CO₂ content is from 12% to 15% for a coal-fired power plant and from 6 to 8% for a gas-fired power plant. In certain chemical processes, such as the manufacture of cement, the CO₂ content may rise up to 30%. The pressure of these gaseous effluents is close to atmospheric pressure.

The objective of post-combustion capture is to extract the dilute CO₂ and it may be integrated into existing installations, by means of a redesign of the whole of the unit. However, the fact of integrating a CO₂ recovery section into an existing unit does not constitute optimum technology and the best way of reducing the recovery energy costs consists in an overall integration considered from the start of the installation project. Post-combustion is currently the best controlled method but also the most expensive.

The second possible route is pre-combustion, the objective of which is to capture the CO₂ during the process of manufacturing the fuel. The fuel (coal, gas, biomass) is converted into a mixture of carbon monoxide and hydrogen. The technique used is either steam reforming in the presence of water, or partial oxidation in the presence of oxygen. The CO, present in the mixture, reacts with the water to form CO₂ and hydrogen (reaction known as water-gas shift reaction). The CO₂, present at contents of 25% to 40%, is then separated from the hydrogen which may be used to produce energy without emission of CO₂.

The third route, oxy-fuel combustion, uses pure oxygen as oxidant. This technology is not strictly speaking CO₂ capture. It is a question of producing a concentrated flue gas containing 90% CO₂ by carrying out a combustion using practically pure oxygen. With recycling of a portion of the CO₂ in replacement for nitrogen from the air, oxy-fuel combustion requires the boilers and burners to be redefined. Another sizable obstacle is the price of oxygen. Oxy-fuel combustion is a technique that is still at the demonstration stage.

Regarding the existing processes for capturing CO₂, they rely on at least one of the following processes:
physical or chemical absorption into a liquid;
adsorption on a solid;
membrane separation;
cryogenics; and
specific formation of gas hydrates.

Chemical absorption is the most commonly used process in post-combustion. Chemical absorption consists of capturing CO₂ using a chemical solvent, which generally comprises amines. Indeed, the use of amines has been known for a long time in gas deacidification. Thus natural gases rich in H₂S and/or CO₂ are treated.

The expression “chemical solvent” is understood to mean a solvent which has a strong chemical interaction (reactivity) and a high affinity with CO₂. One of the drawbacks of these solvents is that their heat of reaction is high and that their regeneration consequently requires a lot of energy (typically heating at 120° C.). In compensation, the affinity is high.

In a conventional process for recovering CO₂ using chemical absorption in post-combustion, the flue gases to be treated are sent to an absorber, in which they are mixed with a chemical solvent. Having greater affinity with the CO₂ molecules than with the other components of the flue gases (especially nitrogen), the solvent captures the CO₂ (it is referred to as an “enriched” solvent) and the other molecules are released from the absorber (treated flue gases).

Almost 90% of the CO₂ of the flue gases is thus captured by the solvent. The enriched solvent is then sent to a regenerator. The device is heated at 120° C., in order to break the bonds between the CO₂ and the solvent. The CO₂ is then isolated, then transported to its storage site. The solvent, returned to its initial form (referred to as “depleted” solvent) is reinjected into the absorber with the flue gases to be treated.

There are three categories of amines capable of constituting a chemical solvent: primary, secondary and tertiary amines. Monoethanolamine (MEA) is more reactive than the more sterically hindered amines (the secondary or tertiary amines) and for this reason dominates the market. The hindered amines used are 2-amino-2-methyl-1-propanol (AMP) or 2-piperidineethanol (PE), which have a weaker interaction with CO₂ and may be easier to regenerate (“Performance and cost analysis for CO₂ capture from flue gas streams: absorption and regeneration aspects”, Veawab, A. et al., (2002), Sixth International Conference on Greenhouse Gas Control Technologies, Kyoto, C4-5).

Another type of hindered amines, KS1 amines, developed by EXXON are used in a urea plant in Malaysia (“Development and Applications of flue gas carbon dioxide recovery”, Mimura, T. et al., (2000), 5th International Conference on Greenhouse Gas Control Technologies, CAIRNS CSIRO, Pub. ISBN 0 643 06672 1).

The main concerns with amines lies in their boiling point which, if it is too low, causes a lot of solvent to be lost which it is then necessary to recover. The problems of corrosion, degradation and oxidation in the presence of O₂, SO₂ or NO₂ are also drawbacks of the chemical absorption process using amines.

Finally, the energy for regenerating chemical solvents is high and may represent up to 80% of the energy of the process for capturing CO₂ (“Separation and Capture of CO₂ from large stationary sources and sequestration in geological formations”, White C. M., et al., (2003), J. of the Air and Waste Management Association, 53, p. 645-715).

Apart from the amines, certain inorganic compounds may be used as chemical solvents. Thus, for example, the Banfield process consists in trapping CO₂ with potassium or sodium salts. Use is conventionally made of potassium carbonate in solution at 20-40% and pressures of 2 to 3 MPa. The main drawback of these inorganic compounds is that they may salt out sodium and/or potassium into the gas produced.

Ammonia also makes it possible to trap CO₂. In particular, it is capable of capturing more CO₂ per kg of active material and of having an easier regeneration than MEA (“Ammonia process for Simultaneous reduction of CO₂, SO₂ and NOₓ”, Yeh, J. T., et al., 19th Annual International Pittsburgh Coal Conference, Pittsburgh, (2002), Paper 45-1). Ammonia nevertheless poses problems due to its volatility.

In pre-combustion, physical absorption is the best way of recovering the CO₂, considering the very different pressures (which may range from 2.5 to 50 MPa) relative to those observed in post-combustion.

Physical absorption uses physical solvents. The expression “physical solvent” is understood to mean a solvent which has a moderate chemical interaction with CO₂. The drawbacks and advantages are the opposite of those of chemical solvents. In physical absorption, the capacity of the solvent follows Henry's law for ideal gas mixtures whereas in chemical absorption, the capacity of the solvent is not linear with the pressure (“Gas cleaning for Advanced coal based power generation”, Thambimuthu, K., (1993), IEA Coal Research, London Report No. IEACR/53).

The choice of a technology depends on numerous factors: partial pressure of CO₂, percentage of CO₂ to be recovered, sensitivity to impurities, presence of particles, cost of additives for minimizing corrosion and fouling.

As examples of physical solvents, mention may be made of methanol (Rectisol®), N-methylpyrrolidone (Purisol®) and polyethylene glycol dimethyl ether (Selexol®).

The Rectisol® process by Lurgi uses methanol at −40° C. and the number of recompression stages for the regeneration is high; this makes this process highly energy consuming.

Reference is made to hybrid absorption for the processes that combine chemical and physical solvents. The Sulfinol® process by Shell and Amisol® process by Lurgi are known, which respectively use a mixture of sulfolane, DIPA and water (one variant replaces DIPA with MDEA) and a mixture of methanol and MEA or DEA. The advantage of hybrid processes is revealed when the gas to be treated is at high pressure. Indeed, the substitution, under these conditions, of a portion of the chemical solvent with a physical solvent makes it possible to globally reduce the energy costs of the regeneration without drastically reducing the absorption capacity.

Nevertheless, even reduced, the energy costs of regenerating a hybrid solvent are significantly higher (depending on the amount of chemical solvent in the mixture) than for a pure physical solvent.

Regarding processes of adsorption (by variation of pressure and/or of temperature), they are not very suitable since their capacities for capturing CO₂ are low and they require too great a regeneration energy. Mention may be made of the regeneration by desorption via electric induction on microporous carbon fibers which appears to be a more promising route (“US DOE integrated collaborative technology development program for CO₂ separation and capture” Klara, S. M. et al., (2002), Environmental Progress, 21, p. 247-253).

Regarding cryogenics, this technology is used for streams which are rich in CO₂, but it does not appear suitable for contents of less than 50% and remains an expensive technique.

The “membrane” route, based either on polymers, or on ceramics, is advantageous for large streams but does not make it possible to easily achieve very high levels of CO₂ capture. It could nevertheless be used in addition to other techniques cited previously.

In the best of cases, the capture, transport and storage of one tonne of CO₂ represents a cost of between 60 and 70 euros, of which 50% to 60% are dedicated to the capture phase.

After capture, the carbon dioxide is generally dehydrated and compressed, in order to be transported to its storage site.

The main challenge for the storage to be deployed on a large scale consists in reducing the energy consumption of the processes. Thus, within the context of the European Castor project, an experiment is being carried out in Denmark in order to attempt to reduce the capture cost to below 30 euros.

Among the various existing technologies for storing CO₂, a first storage technology consists of the injection of CO₂ into the oceans. Several methods are cited in the literature:

injection in gas form at shallow depths, which has a high risk of rising and diffusing into the atmosphere;

dumping carbon dioxide snow from a boat, technology known under the name of “Dry Ice”;

combined injection [seawater-compressed CO₂ (30 bar)] at medium depths (500 m) forming a descending gravity current;

injection of liquid CO₂ from a collection tube starting from the surface and following the continental shelf to a depth of around 1000 m forming a droplet plume;

injection of liquid CO₂ from a long pipe towed by a boat at a depth of around 1000 m forming a droplet plume, technology known as “Towed Pipe”;

injection of liquid CO₂ at very deep depths (more than 3000 meters deep) into sea floor depressions in order to form “lakes”, the CO₂ being converted to hydrates;

injection in the form of gas hydrates directly formed at the surface at deep depths (more than 2000 meters), this method requiring energy in order to form the hydrates;

consumption of CO₂ by marine biomass: in order to stimulate the production of phytoplankton which would consume the CO₂ injected, it would be necessary “to fertilize” the ocean with iron and nitrogen; this technique is the only one to have been the subject of an experiment (off the coast of Hawaii); nevertheless, it has high risks of ecosystem imbalance.

A second storage technology consists of injecting CO₂ into geological formations. The surveying of storage sites has already begun and concerns depleted oil and gas reservoirs, coal seams no longer being exploited and deep aquifers.

Techniques also exist for storage via terrestrial ecosystems, chemical storage and biochemical storage.

However, all the aforementioned technologies have limits. Indeed, additional energy is consumed for the capture of CO₂. This means that a surplus of fuel must be used depending on the type of unit. For powdered coal sites using current technologies, the additional energy requirement varies from 20 to 30%, whereas for natural gas combined cycle (NGCC) units, the requirement lies between 10 and 20%.

For integrated gasification combined cycle (IGCC) systems, this additional requirement is instead estimated between 12 and 20% (IPCC special report on Carbon Dioxide Capture and Storage, prepared by Working Group III of the Intergovernmental Panel on Climate Change, Metz, B., O. Davidson, H. C. de Coninck, M. Loos and L. A. Meyer (eds.), Cambridge University Press, Cambridge, United Kingdom and New York, N.Y., USA, 442 pp.).

The energy expenditure, combined with the problems of oxidation of solvent, of corrosion of installations, of loss of vapor phase, are the main points accounting for the cost of recovering CO₂ today.

The main challenge in order for the storage to be deployed on a large scale consists in reducing the energy consumption of the existing capturing processes. Indeed, in the best case, the capturing, transport and storage of one tonne of CO₂ cost between 60 and 70 euros, of which 70% are devoted to the capturing phase. Due to their high investment cost, the techniques for capturing CO₂ are more suitable for large concentrated emission sources than for sources of low flow.

This is why capturing CO₂ with the existing processes described above is only practicable in thermal power plants, cement works, refineries, plants for producing fertilizer, iron and steel mills, and petrochemical plants where the production of CO₂ is concentrated.

In the case of the chemical absorption by amines or mixtures of amines, an efficient unit equipped with CO₂ capture must respect certain energy limits. European regulation requires that the amount of energy released must not exceed 2 million kilojoules (heating at 120° C.) per tonne of CO₂ captured.

Yet another technique using chilled ammonia made it possible to recover 90% of the CO₂ from the flue gases, but it consumes around 10% of the energy produced in order to chill the ammonia and to subsequently separate it from the CO₂.

The case of absorption by physical solvents currently used also has drawbacks. By way of example, the Rectisol process uses methanol at highly negative temperatures under high pressures: the energy involved originates from thermal and pressure variations between regeneration and absorption.

Certain solvents from the prior art have a high viscosity which leads to higher energy costs for the circulation of the solvent and makes the regeneration step more difficult by slowing down the velocity of the gas at desorption.

The literature provides examples of the insertion of CO₂ into organometallic complexes. Interaction with the metal centers takes place via three mechanisms: Lewis acid site on the carbon (M-C), Lewis base site on one of the oxygens (M-O) and the interaction of the metal with a double bond of CO₂. The insertions are observed in the metal-H, metal-C, metal-O and metal-N bonds as described in Advances in Organo-metallic Chemistry, vol. 22, Stone, F. G. A. and West, R. (1983), Academic Press).

The treatment of titanium or zirconium complexes using CO₂ makes it possible to insert the latter according to the reaction: R₂MR′₂→R₂MCOOR′₂ with M=Zr or Ti, R=Cp or PhCH₂ and R′=Ph, Me or PhCH₂ (Kolomnikov, I. S. et al., Zh. Obshch. Khim., 42, 2232 (1972) (p. 2229 Engl. Transl.).

The same type of reaction may be carried out on MeCu(PPh)₃ etherate (Miyashita A., et coll., J. of Organometal. Chem., 54, 281 (1973)).

It is also known that complexes of titanocene type are capable of substituting two CO ligands with two CO₂ ligands according to the following reaction: 4-(η-C₅H₅)₂Ti(CO)₂+4CO₂→[[η-C₅H₅]₂Ti₂(CO₃)]₂+10CO (Fachinetti, G. et coll., J. of Amer. Chem. Soc., 100, 2716, (1978)). This reaction has the drawback of releasing carbon monoxide; moreover, the complex is expensive to manufacture.

One family of complexes that readily gives insertion reactions, even at pressures of less than 1 bar, are the compounds such as: HM(CO)₅⁻ where M is an element from group 6B of the Periodic Table of the Elements (W, Cr, Mo) which, in the presence of CO₂, give HCO₂M(CO)₅⁻. The decarboxylation may result in the loss of CO; it is difficult in a CO atmosphere (Advances in Organometallic Chemistry, vol. 22, Stone, F. G. A and West, R. (1983), Academic Press).

P. Braustein et coll., (J. of Amer. Chem. Soc., 103, 5115, (1981)) describe the reversible insertion of CO₂ into Pd(II) ethyl(diphenylphosphino)acetate complexes. According to Tsuda et coll. (J.A.C.S., 102, 31, (1980)), a reversibility is also observed in the following reaction scheme:

HOCu(Pet₃)₃→HOCO₂Cu(Pet₃)₃.

Johansson (“Synthesis and Reactivity of (PCP) Palladium Hydroxy Carbonyl and Related Complexes toward CO₂ and Phenylacetylene”, Organometallics, 26(9) 2426-2430 2007 American Chemical Society), shows that palladium complexes of 1,3-bis(di-tert-butylphosphino) benzene (PCP—H) type enable the insertion of CO and of CO₂ in order to give a carbonate-based complex [(PCP)PdOCO₂] [3, PCP=2,6-tert-Bu₂P)C₆H₃].

In the presence of CO₂, another complex of formula [(C₅Me₄H)₂Lu]₂ (μ-η₂:η₂-C₂O₄) is formed by reductive coupling in the presence of CO₂ starting from [(C₅Me₄H)₂Lu(THF)₂ (μ-η₂:η₂-N₂] (“Investigating metal size effects in the Ln2 (μ-η₂:η₂-N₂) reduction systems: reductive reactivity with complexes of the largest and smallest trivalent lanthanide ions, La³⁺ and Lu³⁺”, Evans, W. et coll., Inorganic Chemistry, 48(5), 2001-2009, (2009)).

Another document (“Chemical Absorbent containing organobismuth or organoantimony oxide for trapping and recovering carbon dioxide”, Yin, Shuanfeng et coll., Faming Zhuanli Shenqing Shuomingshu, C N 1011264415 A, 17 Sep. 2008), shows that a complex of [X₅CH₂YCH₂Z]MOM[ZCH₂YCH₂X) type may absorb CO₂ selectively and reversibly. X and Z are phenyl groups substituted by alkyl chains, M is Sb or Bi, and Y is O or S.

Some of these complexes have quite strong interactions with CO₂, but their synthesis cost makes them systems that are difficult to control on an industrial scale.

The insertion of a CO₂ into C—O or C—N bonds may take place reversibly with alcoholates. Thus, t-BuOCu.Ln gives, with CO₂, t-BuOCO₂Cu.L₃ (Tsuda et coll. J.A.C.S., 102, 31 (1980)).

All these systems suffer from several failings: the complexes are expensive to synthesize, in several steps. Furthermore, they are sensitive to water and oxygen, like metallocenes. A number of them are solids or at the very least are not sufficiently liquid at room temperature. All the documents cited use them in solvents which pose problems of toxicity (benzene, THF, etc.).

It therefore appears useful to propose an alternative solution to the capture of CO₂.

The objective of the present invention is therefore to provide a process for capturing carbon oxides, carbon monoxide and/or dioxide, in particular CO₂, that makes it possible to respond to a large number of these drawbacks, using solvents that have improved absorption capacities of said carbon oxides, accelerated absorption kinetics, a high boiling point, a low vapor pressure, a moderate viscosity, etc., and which are readily accessible, that is to say the synthesis of which allows moderate to low production costs.

Another objective of the present invention is to provide a process for capturing carbon oxides, carbon monoxide and/or dioxide, in particular CO₂, which uses a solvent of low corrosivity and that is resistant to degradation, and which has a lower energy expenditure for the regeneration of the solvent.

Another objective of the present invention is to provide a process for recovering carbon oxides, carbon monoxide and/or dioxide, in particular CO₂, which consumes less energy and which is less expensive (in terms of investment costs and operating cost) than the current processes for recovering said carbon oxides.

Surprisingly, the Applicant has observed that certain solvents comprising organometallic compounds have a capacity for absorbing carbon oxides, such as CO and/or CO₂, preferably CO₂, and a regeneration capacity that are substantially greater than those of the physical or chemical solvents currently used in the processes for recovering said carbon oxides.

Thus, and according to a first subject matter, the present invention relates to a process for capturing carbon oxides, carbon monoxide and/or dioxide (CO and/or CO₂) contained in a gas stream, in which the gas stream is brought into contact with a solvent comprising at least one organometallic compound, so that said solvent captures the CO and/or the CO₂ in order to form an enriched solvent.

The present invention especially relates to the use of said capturing process in post-combustion or pre-combustion processes.

According to one preferred aspect, the present invention relates to a process for capturing carbon dioxide (CO₂) contained in a gas stream.

Another subject matter of the present invention is a process for capturing and/or recovering carbon oxides, CO and/or CO₂, preferably CO₂, from an industrial plant comprising:

said process for capturing said carbon oxides as defined previously; and

the regeneration of the enriched solvent, so that said carbon oxides are released from the solvent, the solvent is regenerated and the released carbon oxides being recovered separately.

According to one preferred aspect, the present invention relates to a process for capturing and/or recovering carbon dioxide (CO₂) contained in a gas stream.

More specifically, one subject matter of the present invention is a process for capturing carbon monoxide and/or dioxide (preferably carbon dioxide) contained in a gas stream, in which the gas stream is brought into contact with a solvent comprising at least one organometallic compound. The solvent thus captures the CO and/or CO₂, preferably the CO₂, in order to form an “enriched solvent”.

The expression “gas stream” is understood to mean the combustion flue gases or any gas and/or vapor emission, generally produced by an industrial installation.

The gas stream is in fact a gas mixture containing CO and/or CO₂, and which may also contain, non-limitingly, nitrogen, hydrogen, oxygen, hydrogen sulfide, sulfur dioxide, steam, etc.

By way of example, one subject matter of the process of the invention is in particular the recovery of CO and/or CO₂, preferably CO₂, contained in a gas with a pressure higher than atmospheric pressure. Such a gas is typically a syngas produced by coal gasification (C+H₂O⇄CO+H₂) or by reforming of natural gas (CH₄+H₂O⇄CO+3H₂), followed by a “water-gas shift reaction” (CO+H₂+H₂O⇄2H₂+CO₂). The carbon dioxide should, for example, be removed from the gas obtained, with a view to using the hydrogen as fuel.

The process for capturing CO and/or CO₂, preferably CO₂, according to the invention is advantageously based on the principle of absorption which relies on the transfer of carbon oxides into a solvent comprising, or even consisting of, at least one organometallic compound.

Before carrying out the capture of CO and/or CO₂ according to the process of the invention, the gas stream is optionally subjected to a pretreatment, for example to remove one or more of the compounds, other than the carbon oxides, that are present in the gas stream.

Advantageously, and before being subjected to a capture of CO and/or CO₂ according to the process of the invention, said gas stream has a content of carbon oxides, such as CO and/or CO₂, within the range extending from 1% to 100% by volume, preferably from 1% to 90% by volume, or more preferably still from 1% to 50% by volume, a temperature within the range extending from −40° C. to 100° C., preferably from 20 to 80° C., and a pressure within the range extending from 1 to 80 bar, preferably from 1 to 50 bar.

According to one embodiment of the invention, the process for capturing CO and/or CO₂ is carried out in an absorption column at a temperature within the range extending from −40° C. to 100° C., preferably from 20° C. to 80° C. The pressure in the column is within the range extending from 1 to 80 bar, preferably from 1 to 50 bar. By way of example of the column, use may be made of any type of column, such as a perforated plate column, valve column, bubble-cap column, column with random packing or column with structured packing.

Within the meaning of the invention, the expression “organometallic compound” denotes a chemical compound comprising at least one bond (covalent, dative or ionic bond) between an organic compound and a metal. A chemical compound is said to be organic when it contains at least one carbon atom linked to at least one hydrogen atom.

Advantageously, the organometallic compound has a boiling point of greater than 200° C., preferably greater than 250° C. at atmospheric pressure.

Advantageously, the solvent has a low vapor pressure, for example less than 1 mPa at 25° C., which makes it possible to limit entrainments and losses of solvent at the outlet of the absorber and during the regeneration thereof. Advantageously, the solvent has a viscosity of less than 100 mPa·s at 20° C., preferably of less than 50 mPa·s at 20° C.

In particular, when the process according to the invention uses a plate absorption column, the viscosity has a direct effect on the efficiency of the plates, the efficiency decreases when the viscosity of the solvent increases.

Advantageously, the solvent is a physical solvent. The process according to the invention uses the physical absorption of carbon oxides, that is to say that there is no chemical reaction between said carbon oxides and the physical absorption solvent. The regeneration of the solvent according to the invention is thus facilitated.

According to the present invention, the process is based on the use of at least one organometallic compound comprising at least, preferably one, unit of formula M(Rₓ)ₙ, in which:
M is a metal chosen from metals from columns 3, 4 and 5 of the Periodic Table of the Elements;
R represents a hydrocarbon-based ligand, preferably comprising at least one bond of the metal with a heteroatom;
x is an integer between 1 and n; and
n represents the number of ligands, and is an integer taking the values 1 to 5, limits included.

The metals from columns 3, 4 and 5 of the Periodic Table are the metals of scandium type, of platinum type and of vanadium type, respectively. Among these metals, those from columns 4 and 5 of the Periodic Table are preferred, and among these titanium, zirconium and vanadium are more preferred. Titanium and zirconium are very particularly suitable for the requirements of the present invention.

The hydrocarbon-based ligand R is a saturated or unsaturated hydrocarbon-based ligand, chosen from alkyls, cycloalkyls, aryls, arylalkyls and alkylaryls comprising from 1 to 24 carbons; each R ligand may be functionalized, and preferably comprises one or more heteroatoms, such as, but non-limitingly, chosen from halogen, oxygen, sulfur, nitrogen, silicon, phosphorus, etc. Preferably the heteroatom(s) is(are) chosen from oxygen, sulfur and nitrogen, more preferably the heteroatom(s) is(are) oxygen.

The term “unit” is understood to mean a portion, or the whole, of the overall chemical formula of the organometallic compound. Preferably, the organo-metallic compound corresponds to the formula M(Rₓ)ₙ, where M, R, X and n are as defined above.

According to one preferred embodiment, the at least one organometallic compound comprises at least one metal-heteroatom(s) bond, the bond of which between the heteroatom and the metal is not very polarized. The organometallic compounds that comprise at least one, preferably at least two, more preferably at least three, more preferentially at least four metal-hetero—atom-carbon linkages are preferred, in which linkages the heteroatom is preferably chosen from oxygen, nitrogen and sulfur, very preferably the heteroatom is oxygen.

According to another embodiment, the organometallic compounds comprising at least one, preferably at least two, more preferably at least three, more preferentially at least four metal-oxygen bonds are also preferred.

The expression “functionalized ligand” is understood to mean a ligand comprising at least one chemical function, chosen from, non-limitingly, hydroxyl, alcohol, alkoxy, carbonyl (such as aldehyde or ketone), carboxyl (carboxylic acid or a carboxylic anhydride), amine, phosphate, thiol functions, etc. Preferably, the ligand comprises at least one alkoxy function, more preferably at least two alkoxy functions, more preferentially at least three alkoxy functions, particularly preferably four alkoxy functions.

Advantageously, the metal M is chosen from titanium, zirconium and vanadium, and R represents an alkoxy comprising from 1 to 10 carbon atoms, preferably from 1 to 8 carbon atoms, more preferably from 1 to 4 carbon atoms, in a linear or branched chain, preferably in a linear chain.

As examples of organometallic compounds that are particularly preferred within the context of the present invention, mention may be made, non-limitingly, of the organometallic compounds chosen from tetraethoxytitanium [Ti(OEt)₄], tetrapropoxyzirconium [Zr(OPr)₄], tetrabutoxyzirconium [Zr(OBu)₄], and complexes based on phosphate(s) and on titanate(s) and/or on zirconate(s).

Thus, the process according to the present invention uses at least one organometallic compound as has just been defined. The organometallic compound(s) is(are) advantageously used in solution in one or more solvent agents. Advantageously, said solution comprises from 1% to 100%, preferably from 50% to 100%, by volume, of at least one organometallic compound defined previously, relative to the total weight of the (solvent agent(s)+organometallic compound(s)) solution.

The solvent agent(s) represent(s) from 1% to 99% by volume of the solvent comprising the at least one organometallic compound as defined previously. As non-limiting examples, the solvent agent(s) is(are) chosen from methanol, diethylene glycol dimethyl ether, better known under the name diglyme, monoethylene, diethylene, triethylene or polyethylene glycol dimethyl ether or diethyl ether, monopropylene, dipropylene, tripropylene or polypropylene glycol dimethyl ether or diethyl ether, acetone, sulfolane, dimethyl sulfoxide, etc. and also mixtures of two or more thereof in any proportions.

According to one preferred embodiment of the process according to the present invention, the organometallic compound(s) is(are) used as is, that is to say without being in solution in a solvent. Preferably, the organometallic compound is tetraethoxy-titanium Ti(OEt)₄, or tetrabutoxyzirconium Zr(OBu)₄.

Advantageously, the amount of organometallic compound(s) brought into contact with the gas stream is within the range extending from 10⁻⁴ to 10, preferably within the range extending from 10⁻³ to 10⁻¹, expressed as a ratio (L/G) of the liquid volume of organometallic compound relative to the volume (expressed under normal temperature and pressure conditions, that is to say at a temperature of 0° C. (273.15 K) and a pressure of 1 bar) of gas containing the carbon oxide or oxides to be captured. In this L/G ratio, the volumes and volume flow rates are expressed in the same units.

Preferably, the gas stream is dried before capturing CO and/or CO₂, this drying being carried out according to well known and controlled processes.

According to one embodiment of the process of the present invention, the preferred organometallic compounds are those for which the vapor pressure is less than 1 mm of mercury (133 Pa) at ambient temperature. In particular, tetraethoxytitanium has a boiling point of 151° C. under 10 mm of mercury (1.33 kPa), and is not capable of oxidation, nor of promoting the corrosion of the device implementing the process according to the invention.

Moreover, tetraethoxytitanium is not capable of oxidation, nor does it promote corrosion. It is sensitive to hydrolysis in an acid or basic medium, but relatively little at a pH close to neutrality.

The organometallic compounds that can be used in the process of the present invention are stable, easy to regenerate and recycle, and their service life is long.

The Applicant has observed that the organometallic compounds of formula M(Rₓ)ₙ, where M, R, x and n are as defined previously, absorb significantly more carbon oxides, in particular carbon dioxide, than the known physical or chemical solvents. Thus, acetone absorbs, for example under 1 bar, 7.6 normal liters (NL) of CO₂/kg. Other ketones, such as methyl ethyl ketone, absorb, per mole, similar amounts. Methanol, a reference compound, itself absorbs 4.6 NL of CO₂/kg.

Moreover, the organometallic compounds described above have the advantage of exhibiting a reversible capacity (capacity to work between absorption and regeneration) that is greater than that of the other known physical or chemical solvents. A moderate increase in the temperature is sufficient to eliminate all the CO₂ captured/trapped by the organometallic compounds described in this invention.

Owing to the organometallic compounds defined above, the volume of carbon oxides, in particular of CO₂, captured at 25° C. under 1 bar absolute of CO and/or CO₂, is at least 8 normal liters per kilogram of organometallic solvent, preferably at least 10 normal liters per kilogram of organometallic solvent, or better still at least 12 normal liters per kilogram of organometallic solvent.

According to one aspect, one subject matter of the present invention is the use of the capturing process according to the invention in a process for the pre-combustion of a fuel, such as coal, hydrocarbon-based petroleum feedstocks, gas, and/or biomass.

As another subject matter, the present invention relates to the use of the capturing process according to the invention in a post-combustion process removing CO and/or CO₂, more particularly CO₂, from a combustion gas discharged by an industrial plant, such as a coal-fired power plant, an integrated gasification combined cycle (IGCC) plant, a power plant, a cement works, a refinery, a fertilizer manufacturing plant, an iron and steel mill or a petrochemical plant.

More specifically, one subject of the present invention is a process for recovering carbon oxides, CO and/or CO₂, and preferably CO₂, from an industrial plant, comprising:

a process for capturing carbon oxides as defined previously in order to form a solvent enriched in said carbon oxides;
a step of regenerating the enriched solvent, so that said carbon oxides are released from the solvent, the solvent is regenerated and said released carbon oxides being recovered separately.

Advantageously, the step of regenerating the enriched solvent comprises a reduction in the pressure of the enriched solvent, preferably to atmospheric pressure, and/or an increase in the temperature of the enriched solvent up to a temperature below 120° C., preferably below 100° C. and more preferably still below 50° C.

According to a first embodiment of the present invention, the step of regenerating the enriched solvent is carried out by pressure reduction of the solvent, in particular if the carbon oxide capturing pressure (absorption pressure) is greater than 1 bar. This regeneration via expansion is conventionally carried out, for example by passing the enriched solvent into a flash drum. On the one hand, a gas mixture very rich in carbon oxides (the content of which depends on the selectivity of the solvent with respect to the other compounds of the gas stream to be treated) and, on the other hand, a solvent depleted in carbon oxides, the residual content of which depends on the expansion pressure, are obtained.

According to one alternative or complementary embodiment of the first embodiment above, the regeneration of the enriched solvent is carried out by heating in a solvent regeneration column, in particular if the absorption was carried out at a relatively low temperature (temperature of the absorption below +20° C.), which makes it possible to obtain a result equivalent to the pressure reduction but with a higher energy cost, due to the energy to be provided for the heating.

It is also possible to envisage a combination of these two regeneration methods, that is to say a pressure reduction associated with a rise in temperature, the desorption of the carbon oxides, and preferably of the carbon dioxide being favored by the low pressure and the high temperature in the regenerator.

The regenerated solvent (also referred to as “lean solvent”) is then recycled to the absorption step. The carbon oxides separated from the gas stream may then be sent to a storage location for example, such as those described previously.

Advantageously, said process for recovering carbon oxides, and in particular carbon dioxide, also comprises at least one of the following steps: dehydration, compression, transport, storage and/or upgrading of the carbon oxide(s) recovered.

The examples below will make the present invention better understood and illustrate it without limiting the scope thereof.

### EXAMPLE 1

Introduced into a jacketed steel 1 l reactor, equipped with a temperature probe, with a connection to a vacuum pump and with a connection to a 1 l ballast containing 10 bar absolute of pressure of CO₂, provided with a discharge valve and with a finely graduated manometer, were 250 g of Ti(OEt)₄ (tetraethyl titanate or tetraethoxy titanium). These 250 g corresponded to 230 ml (density 1.088).

The solvent was first degassed by putting the reactor under vacuum (<10 mm of mercury, i.e. 1.33 kPa), so as to expel as much of the air initially present in the installation as possible and, optionally, that degassed from the solvent owing to the drop in pressure.

While keeping the solvent under vacuum with the reactor sealed, the temperature was set at 25° C. and carbon dioxide was introduced while regulating the discharge valve so as to maintain 1 bar absolute in the reactor containing the solvent. Indeed, as soon as the solvent started to be stirred, a drop in pressure corresponding to the solubilization of the CO₂ was observed. CO₂ originated from the ballast, in which the initial pressure was 10.0 bar absolute.

When the solvent was saturated with CO₂, the pressure in the ballast no longer decreased and the final pressure achieved was noted. Knowing the difference in pressure in the ballast (Pᵢₙᵢₜᵢₐₗ−P_{final}), the volume of the ballast, the empty volume (without solvent) of the installation, the volume of solvent and also the pressure and temperature in the reactor, the volume of CO₂ solubilized by the solvent was deduced therefrom by applying the ideal gas law.

In the case of example 1 with Ti(OEt)₄, the volume of CO₂ solubilized at 25° C. under 1 bar absolute, expressed via calculation under normal temperature and pressure conditions, was 18.0 normal liters per kilogram (NL/kg) of pure Ti(OEt)₄ or else 19.6 normal liters per liter of pure Ti(OEt)₄.

### COMPARATIVE EXAMPLE 1

Example 1 was reproduced by changing Ti(OEt)₄ for acetone (250 g, 313 ml). Given the volatility of acetone, the prior degassing was carried out in the vicinity of 0° C. The temperature was then brought to 25° C., once the installation was under vacuum and the reactor was sealed.

The solubility of CO₂ was then measured 3 times, for which the following values were respectively found: 8.0, 6.9 and 7.3 NL/kg of acetone, i.e. on average 7.4 NL/kg (or else 5.9 normal liters per liter) of acetone. The value found in the literature (IUPAC—Solubility Data Series—Volume 50—Pergamon Press, is 7.5 NL/kg (normal liters per kg, or 6.0 normal liters per liter) of acetone.

### COMPARATIVE EXAMPLE 2

Example 1 was reproduced by changing Ti(OEt)₄ for Si(OMe)₄ (tetramethoxysilane; 250 g, 266 ml). The prior degassing was, as in example 1, carried out directly at 25° C.

The solubility of CO₂ was then measured, for which the value of 3.3 normal liters per kg (or else 3.1 normal liters per liter of tetramethoxysilane) was found.

### COMPARATIVE EXAMPLE 3

Example 1 was reproduced by changing Ti(OEt)₄ for diglyme (diethylene glycol dimethyl ether) (250 g, 265 ml). The prior degassing was, as in comparative example 1, carried out in the vicinity of 0° C. The temperature is then brought back to 25° C., once the installation was under vacuum and the reactor was sealed.

The solubility of CO₂ was then measured, for which a value of 5.4 normal liters per kg (or else 5.1 normal liters per liter of diglyme) was found. The value in the literature (IUPAC—Solubility Data Series—Volume 50—Pergamon Press) is 5.4 normal liters per kg (or 5.1 normal liters per liter) of diglyme.

### EXAMPLE 2

3 mixtures of Ti(OEt)₄ and diglyme were prepared (80/20, 50/50 and 20/80 by weight) and example 1 was reproduced by changing Ti(OEt)₄ for each of the mixtures (250 g). The prior degassing was, as in example 1, carried out directly at 25° C. The solubility of CO₂ was then measured and the results are given in table 1 below:

TABLE 1

| | | | Solubility of CO₂ |
|---|---|---|---|
| | | | in normal liters |
| | | % | per kg of pure |
| Example No. | % Ti(OEt)₄ | diglyme | solvent |
| Example 1 | 100 | 0 | 18.0 |
| Example 2.2 | 50 | 50 | 12.1 |
| Example 2.3 | 20 | 80 | 8.7 |
| Comparative 2 | 0 | 100 | 5.4 |

### EXAMPLE 3

Example 1 was reproduced with Ti(OEt)₄ (250 g, 230 ml) but this time under pressures between 2 bar and 10 bar absolute. The prior degassing was, as in example 1, carried out directly at 25° C.

The solubility of CO₂ was then measured, for which values between 10.3 and 11.5 normal liters per kg (or else between 11.3 and 12.5 normal liters per liter) of tetraethoxy titanium and per bar were found.

### EXAMPLE 4

Example 1 was reproduced by changing Ti(OEt)₄ for Zr(O-n-Pr)₄ (tetrapropoxy zirconium at 70% by weight in propanol). The prior degassing was, as in example 1, carried out directly at 25° C.

The solubility of CO₂ was then measured, for which a value of 20.8 normal liters per kg (or else 21.5 normal liters per liter) of tetrapropoxy zirconium at 70% by weight in propanol was found.

### EXAMPLE 5

Example 1 was reproduced by changing Ti(OEt)₄ for other derivatives of titanium (250 g each time). The prior degassing was, as in example 1, carried out directly at 25° C.

The solubility of CO₂, expressed in normal liters per kg (NL/kg) or per liter (NL/L) of solution, was then measured, for which the results presented in table 2 below were found:

TABLE 2

| | Solvent | Solubility | Solubility of |
|---|---|---|---|
| | (purity > | of CO₂ | CO₂ |
| Example No. | 95%) | (NL/L) | (NL/kg) |
| Example 1 | Ti(OEt)₄ | 19.6 | 18.0 |
| Example 5.1 | Ti(O-n-Bu)₄ | 15.6 | 15.6 |
| Example 5.2 | Ti(O- | 10.8 | 12.0 |
| | ethylhexyl)₄ | | |

It was observed that the weight capacities decreased with the increase in the weight of the ligands.

### EXAMPLE 6

Example 1 was reproduced by changing Ti(OEt)₄ for zirconium derivatives (250 g each time). The prior degassing was, as in example 1, carried out directly at 25° C.

The solubility of CO₂ was then measured, for which the following results were found: Table 3

TABLE 3

| | | Solubility | Solubility of |
|---|---|---|---|
| | | of CO₂ | CO₂ |
| Example No. | Solvent | (NL/L) | (NL/kg) |
| Example 4 | Zr(O-n-Pr)₄ | 21.5 | 20.8 |
| | 70% in n- | | |
| | propanol | | |
| Example 6.1 | Zr(O-n-Bu)₄ | 31.0 | 29.4 |
| | 80% in n- | | |
| | butanol | | |
| Example 6.2 | Zr(O-n-Pr)₂ | 17.1 | 15.0 |
| | (diethyl- | | |
| | citrato)₂ | | |
| | 88% in n- | | |
| | butanol | | |

### EXAMPLE 7

Example 1 was reproduced by changing Ti(OEt)₄ for Zr(O-n-Bu)₄ as a mixture in acetone (30% by weight of acetone), the Zr(O-n-Bu)₄ being itself initially an 80% mixture in n-propanol. The mixture obtained had the following weight composition: 56% of tetrabutoxy zirconium, 14% of n-propanol and 30% of acetone, by weight.

The prior degassing was, as in example 1, carried out directly at 25° C. The effect of the pressure was observed between 1 bar and 19 bar absolute (total pressure=partial pressure of CO₂).

The solubility of CO₂ was then measured, for which the results presented in table 4 below were found:

TABLE 4

| Pressure of CO₂ | Solubility of CO₂ |
|---|---|
| (in bar absolute) | (NL/kg) |
| 1.0 | 26 |
| 4.0 | 37 |
| 9.0 | 55 |
| 14.0 | 71 |
| 19.0 | 88 |

The examples show that the process for capturing CO₂ according to the invention (examples 1 to 7) has a greater capacity for absorbing CO₂ than the prior art processes (comparative examples 1, 2 and 3).

By comparing the regeneration of the same solvents, a better capacity for regeneration of the solvents is also observed with the process of the present invention.

1. A process for capturing carbon oxides, carbon monoxide and/or dioxide, in particular CO₂, contained in a gas stream, in which process the gas stream is brought into contact with a solvent comprising at least one organometallic compound, so that said solvent captures the CO and/or the CO₂ in order to form an enriched solvent.

2. The process as claimed in claim 1, wherein it comprises a step of capturing and a step of recovering carbon oxides, CO and/or CO₂, preferably CO₂, from an industrial plant comprising:
said process for capturing said carbon oxides as claimed in claim 1; and
the regeneration of the enriched solvent, so that said carbon oxides are released from the solvent, the solvent is regenerated and the released carbon oxides being recovered separately.

3. The process as claimed in claim 1, wherein said gas stream has a content of carbon oxides, such as CO and/or CO₂, within the range extending from 1 to 100% by volume, preferably from 1 to 90% by volume, more preferably from 1% to 50% by volume, a temperature within the range extending from −40° C. to 100° C., preferably from 20 to 80° C., and a pressure within the range extending from 1 to 80 bar, preferably from 1 to 50 bar.

4. The process as claimed in claim 1, wherein the at least one organometallic compound has a boiling point above 200° C. at atmospheric pressure, preferably above 250° C. at atmospheric pressure.

5. The process as claimed in claim 1, in which the solvent has a viscosity of less than 100 mPa·s at 20° C., preferably of less than 50 mPa·s at 20° C.

6. The process as claimed in claim 1, wherein the solvent is a physical solvent.

7. The process as claimed in claim 1, wherein said at least one organometallic compound comprises at least, preferably one, unit of formula M(Rₓ)ₙ, in which:
M is a metal chosen from metals from columns 3, 4 and 5 of the Periodic Table of the Elements;
R represents a hydrocarbon-based ligand, preferably comprising at least one bond of the metal with a heteroatom;
x is an integer between 1 and n; and
n represents the number of ligands, and is an integer taking the values 1 to 5, limits included.

8. The process as claimed in claim 7, wherein M is chosen from titanium, zirconium and vanadium.

9. The process as claimed claim 7, wherein M is chosen from titanium, zirconium and vanadium, and R represents an alkoxy comprising from 1 to 10 carbon atoms, preferably from 1 to 8 carbon atoms, more preferably from 1 to 4 carbon atoms, in a linear or branched chain, preferably in a linear chain.

10. The process as claimed in claim 1, wherein the at least one organometallic compound is chosen from tetraethoxytitanium [Ti(OEt)₄], tetrapropoxyzirconium [Zr(OPr)₄], tetrabutoxyzirconium [Zr(OBu)₄], and complexes based on phosphate(s) and on titanate(s) and/or on zirconate(s).

11. The process as claimed in claim 1, wherein said solvent comprises from 1 to 100% by volume of at least one organometallic compound out of the total weight of solution (solvent+organometallic compound(s)).

12. The process as claimed in claim 1, wherein the solvent also comprises from 1 to 99% of at least one solvent agent chosen from methanol, diethylene glycol dimethyl ether, monoethylene, diethylene, triethylene or polyethylene glycol dimethyl ether or diethyl ether, monopropylene, dipropylene, tripropylene or polypropylene glycol dimethyl ether or diethyl ether, acetone, sulfolane, dimethyl sulfoxide, etc. and also mixtures of two or more thereof in any proportions.

13. The process as claimed in claim 1, wherein the amount of organometallic compound(s) brought into contact with the gas stream is within the range extending from 10⁻⁴ to 10, preferably within the range extending from 10⁻³ to 10⁻¹, expressed as a ratio of the liquid volume of organometallic compounds relative to the volume (expressed under normal temperature and pressure conditions) of gas containing the carbon oxide or oxides to be captured.

14. The use of the process as claimed in claim 1, in a process for precombustion of a fuel, such as coal, hydrocarbon-based petroleum feedstocks, gas, and/or biomass.

15. a method for a post-combustion process for removing CO and/or CO₂ from a combustion gas discharged by an industrial plant, such as a coal-fired power plant, an integrated gasification combined cycle (IGCC) plant, a power plant, a cement works, a refinery, a fertilizer manufacturing plant, an iron and steel mill or a petrochemical plant which comprises using the process according to claim 1.

16. A process for recovering carbon oxides, CO and/or CO₂, and preferably CO₂, from an industrial plant, comprising:
a process for capturing said carbon oxides as claimed in claim 1 in order to form a solvent enriched in said carbon oxides;
a step of regenerating the enriched solvent, so that said carbon oxides are released from the solvent, the solvent is regenerated and said released carbon oxides being recovered separately.

17. The process as claimed in claim 16, wherein the step of regenerating the enriched solvent comprises a reduction in the pressure of the enriched solvent and/or an increase in the temperature of the enriched solvent up to a temperature below 120° C., preferably below 100° C. and more preferably still below 50° C.

18. The process as claimed in claim 16, comprising, in addition, at least one of the following steps: dehydration, compression, transport, storage and/or upgrading of the recovered carbon oxide(s).
